(19) United States
(12) Patent Application Publication
(10) Pub. No.: US 2020/0248057 A1
(43) Pub. Date: Aug. 6, 2020

(54) LATENT HEAT STORAGE MATERIAL, COLD STORAGE PACK, COOLING CONTAINER, LOGISTIC PACKAGING CONTAINER, AND COOLING UNIT

(71) Applicant: SHARP KABUSHIKI KAISHA, Sakai City, Osaka (JP)

(72) Inventors: KYOHEI SEZUKURI, Sakai City, Osaka (JP); MASAKAZU KAMURA, Sakai City, Osaka (JP); SATORU MOTONAMI, Sakai City, Osaka (JP); YUKA UTSUMI, Sakai City, Osaka (JP); KATSUYA KIDO, Sakai City, Osaka (JP)

(21) Appl. No.: 16/634,066

(22) PCT Filed: Jul. 30, 2018
(86) PCT No.: PCT/JP2018/028390

§ 371 Date: Jan. 24, 2020

(30) Foreign Application Priority Data
Jul. 31, 2017 (JP) 2017-148381

(51) Int. Cl. C09K 5/06; F28D 20/02; B65D 81/18; A23L 3/36

(52) U.S. Cl. CPC C09K 5/066; F28D 20/02; A23V 2002/00; A23L 3/363; B65D 81/18

(57) ABSTRACT

The present invention, in an embodiment thereof, provides a latent heat storage material containing a supercooling inhibitor that, if added to an aqueous solution of an inorganic salt including sodium chloride, restrains supercooling by unfailingly precipitating as crystals upon cooling and therefore only marginally lowers the melting point and reduces latent heat. The latent heat storage material contains: an aqueous solution of sodium chloride; and a eutectic aqueous solution of sodium chloride and disodium hydrogen phosphate in an amount that, in comparison with the eutectic aqueous solution of sodium chloride, is greater than or equal to an amount that gives a saturation concentration at 0° C. This arrangement makes a sufficient amount of latent heat available for cooling white restraining supercooling, by using a latent heat storage material containing a supercooling inhibitor that restrains supercooling by unfailingly precipitating as crystals upon cooling and that therefore only marginally lowers the melting point and reduces latent heat.

### TECHNICAL FIELD

The present invention relates to latent heat storage materials, cold storage packs, cooling containers, logistic packaging containers, and cooling units.

### BACKGROUND ART

Foods that need to be kept at freezing temperatures, such as frozen meat and vegetables, frozen processed food, and ice cream, can be stored for an extended period of time in an environment at or below −18° C., substantially without losing their quality. These foods are therefore stored in a cooling container capable of maintaining the −18° C. or lower temperature. Once the electric power supply to the cooling container is disrupted, for example, in a power failure or when the cooling container is operating in defrost mode, the internal temperature of the cooling container rises, which may allow microorganisms to multiply and the foods to melt. Food quality will inevitably fall. There is consequently a need for a means to maintain the cooling container at or below −18° C. for an extended period of time during a power supply disruption

Latent heat storage materials exploit the solid-to-liquid phase transition to keep an object at its melting temperature for a period. For example, for cold storage at or below −18° C., a cold storage pack may be used that contains, as a thermal storage base material, an aqueous solution of sodium chloride having a melting point of approximately −21° C. However, the aqueous solution of an inorganic salt causes supercooling as shown in FIG. 1, and the base material does not solidify at the melting point. Temperature needs to be lowered to or below approximately −28° C. in order to unfailingly solidify an aqueous solution of sodium chloride having a melting point of approximately −21° C. The cooling container consumes increasingly large power as the temperature setting is lowered. It is therefore necessary to restrain supercooling in order to reduce the cost of running the cooling container.

A known supercooling restraining method is to have crystals of an inorganic salt other than the base material (solute) coexist in the aqueous solution serving as the thermal storage base material and solidify the aqueous solution using the crystals as nuclei in cooling, so that the onset temperature of solidification approaches the melting point. Another method is to adjust the added amount in such manner that the inorganic salt providing nuclei is uniformly dissolved at room temperature for uniformity of the aqueous solution and precipitates as crystals upon cooling of the aqueous solution due to decreasing solubility.

Patent Literature 1 discloses technology for preventing supercooling of a cold storage material containing an aqueous solution of sodium chloride as a cold storage medium, by using sodium sulfate as a supercooling inhibitor,

### CITATION LIST

### Patent Literature

Patent Literature 1: Japanese Unexamined Patent Application Publication, Tokukaihei, No. 11-92756

### SUMMARY OF INVENTION

### Technical Problem

Addition of an inorganic salt, to an aqueous solution generally lowers the melting point due to freezing point depression and reduces the latent heat (heat absorption upon melting), thereby disabling the maintaining of the cold insulation temperature and time that would be otherwise achieved when the base material is used alone. Meanwhile, many common supercooling inhibitors are hydrate-forming inorganic salts and remove water from the aqueous solution when they precipitate. It is therefore difficult to maintain the solute concentration in the aqueous solution if such a supercooling inhibitor is used. For example, as shown in the phase diagram in FIG. 2, the aqueous solution of sodium chloride exhibits a maximum latent heat during melting at about −21° C. if the aqueous solution has a eutectic concentration (i.e., a concentration at which the aqueous solution produces only eutectic crystals of water and the solute in solidification). If the concentration deviates even only slightly, however, the latent heat decreases due to the formation of ice or sodium chloride dihydrate. Maintaining the concentration is therefore a serious issue in maintaining the cold. insulation time. The same issue is found not only in the aqueous solution of sodium chloride, but also in aqueous solutions of sodium chloride and other inorganic salts.

Patent Literature 1 is silent about latent heat decreases caused by addition of sodium sulfate (supercooling inhibitor) and latent heat decreases caused by changes in concentration of the thermal storage base material in the precipitation of sodium sulfate.

The present invention, in an embodiment thereof, has been made in view of these problems and has an object to provide a latent heat storage material containing a supercooling inhibitor that, if added to an aqueous solution of sodium chloride, restrains supercooling by unfailingly precipitating as crystals upon cooling and therefore only marginally lowers the melting point and reduces latent heat.

### Solution to Problem

To achieve this object, the present invention, in an embodiment thereof, takes the following measures. Specifically, the present invention, in an embodiment thereof, is directed to a latent heat storage material including an inorganic salt and water as a base material, wherein the inorganic salt includes at least sodium chloride, the inorganic salt and the water form a eutectic mixture, and the latent heat storage material contains disodium hydrogen phosphate in an amount that, in comparison with the base material, is greater than or equal to an amount that gives a saturation concentration at a temperature at which the eutectic mixture melts.

### Advantageous Effects of Invention

The present invention, in an embodiment thereof, makes a sufficient amount of latent heat available for cooling while restraining supercooling, by using a latent heat storage material containing: an aqueous solution of an inorganic salt including sodium chloride; and a supercooling inhibitor that restrains supercooling by unfailingly precipitating as crystals upon cooling and that therefore only marginally lowers the melting point and reduces latent heat.

### BRIEF DESCRIPTION OF DRAWINGS

FIG. 1 is a graph representing an exemplary supercooling phenomenon.

FIG. 2 is a phase diagram for the aqueous solution of sodium chloride.

FIG. 3 is a table showing the solubility of disodium hydrogen phosphate.

FIG. 4 is a conceptual drawing depicting the supercooling inhibiting effect and amount of latent heat of disodium hydrogen phosphate.

FIG. 5 is a table showing changes in sodium chloride concentrations in aqueous solutions when disodium hydrogen phosphate or sodium sulfate is added to the aqueous solution.

FIG. 6 is a graph representing results of measurement of the temperature of solutions during solidification using a thermocouple for Example 1 and Comparative Example 1.

FIG. 7 is a table showing an onset temperature of solidification for Examples 1 and 2 and Comparative Example 1.

FIG. 8 is a graph representing results of measurement of the temperature of solutions during melting using a thermocouple for Example 1 and Comparative Example 1.

FIG. 9 is a table showing a melting point for Examples 1 and 2 and Comparative Example 1.

FIG. 10 is a graph representing results of DSC measurement for Example 1 and Comparative Example 1.

FIG. 11 is a table showing a melting point and the amount of latent heat generated during melting for Example 1 and Comparative Example 1.

FIG. 12 is a graph representing a latent heat value in Comparative Example ere anhydrous disodium hydrogen phosphate is added to water.

FIG. 13 is a cross-sectional view of an exemplary cold storage pack in accordance with a first embodiment.

FIG. 14A is a conceptual drawing illustrating a manufacturing step for a cold storage pack 100 in accordance with the first embodiment.

FIG. 14B is a conceptual drawing illustrating a manufacturing step for the cold storage pack 100 in accordance with the first embodiment.

FIG. 14C is a conceptual drawing illustrating a manufacturing step for the cold storage pack 100 in accordance with the first embodiment.

FIG. 15A is a cross-sectional view of an exemplary cooling container in accordance with a second embodiment.

FIG. 15B is a cross-sectional view of an exemplary cooling container in accordance with the second embodiment.

FIG. 15C is a cross-sectional view of an exemplary cooling container in accordance with the second embodiment.

FIG. 15D is a cross-sectional view of an exemplary cooling container in accordance with the second embodiment.

FIG. 16 is a cross-sectional view of an exemplary logistic packaging container in accordance with a third embodiment.

FIG. 17 is a cross-sectional view of a variation example of the logistic packaging container in accordance with the third embodiment.

FIG. 18 is a cross-sectional view of a variation example of the logistic packaging container in accordance with the third embodiment.

FIG. 19 is a conceptual drawing illustrating an example of how a logistic packaging container in accordance with the third embodiment is used.

FIG. 20 is a schematic illustration of an exemplary cooling unit in accordance with a fourth embodiment.

FIG. 21 is a schematic illustration of the exemplary cooling unit in accordance with the fourth embodiment.

FIG. 22 is a schematic illustration of an exemplary cooling unit in accordance with the fourth embodiment,

FIG. 23 is a schematic illustration of the exemplary cooling unit in accordance with the fourth embodiment.

FIG. 24 is a conceptual drawing illustrating an example of how a cooling unit in accordance with the fourth embodiment is used.

FIG. 25 is a cross-sectional view of an example of how the cooling unit accordance with the fourth embodiment is used.

FIG. 26 is a graph representing results of measurement of the temperature of solutions during solidification using a thermocouple in a temperature-variable thermostatic chamber for Comparative Example 2 and Example 3.

FIG. 27 is a graph representing results of measurement of the temperature of solutions during melting using a thermocouple in a temperature-variable thermostatic chamber for Example 3 and Comparative Example 2.

FIG. 28 is a graph representing results of DSC measurement for Example 3 and Comparative Example 2.

FIG. 29 is a table showing a melting point and the amount of latent heat generated during melting for Example 3 and Comparative Example 2, as determined from the results of measurement shown in FIG. 28.

FIG. 30 is a graph representing results of measurement of the temperature of solutions during solidification using a thermocouple in a temperature-variable thermostatic chamber for Comparative Example 3 and Example 4.

FIG. 31 is a graph representing results of measurement of the temperature of solutions during melting using a thermocouple in a temperature-variable thermostatic chamber for Example 4 and Comparative Example 3.

FIG. 32 is a table showing a melting point and the amount of latent heat generated during melting for Example 4 and Comparative Example 3.

FIG. 33 is a graph representing results of measurement of the temperature of solutions during solidification using a thermocouple in a temperature-variable thermostatic chamber for Comparative Examples 4 and 5.

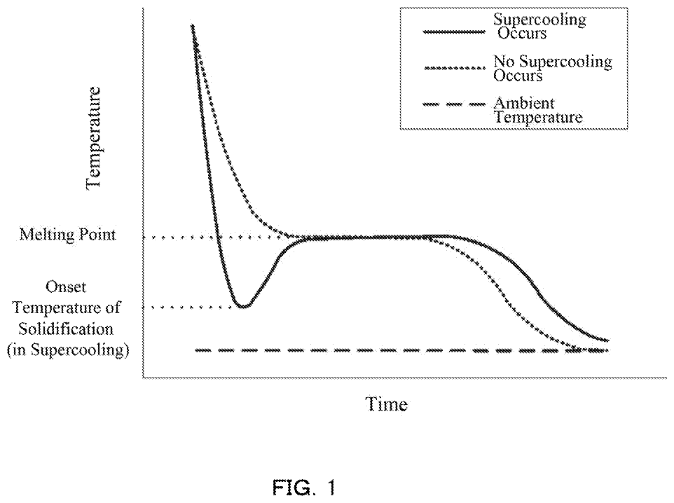

### DESCRIPTION OF EMBODIMENTS

The inventors of the present invention have found that adding disodium hydrogen phosphate as a supercooling inhibitor to an aqueous inorganic salt solution containing a eutectic concentration of sodium chloride restrains supercooling and additionally only marginally reduces the amount of latent heat, which has led to the present invention.

The inventors of the present invention hence have made a sufficient amount of latent heat available for cooling while restraining supercooling, by using a latent heat storage material containing an aqueous solution of sodium chloride. The following will specifically describe embodiments of the present invention with reference to drawings.

### First Embodiment

### Composition of Latent Heat Storage Material

A latent heat storage material in accordance with the present invention contains an aqueous solution of sodium chloride. The latent heat storage material contains an aqueous solution of sodium chloride having a eutectic concentration and disodium hydrogen phosphate in an amount that, in comparison with the aqueous solution of sodium chloride having the eutectic concentration, is greater than or equal to an amount that gives a saturation concentration at 0° C.

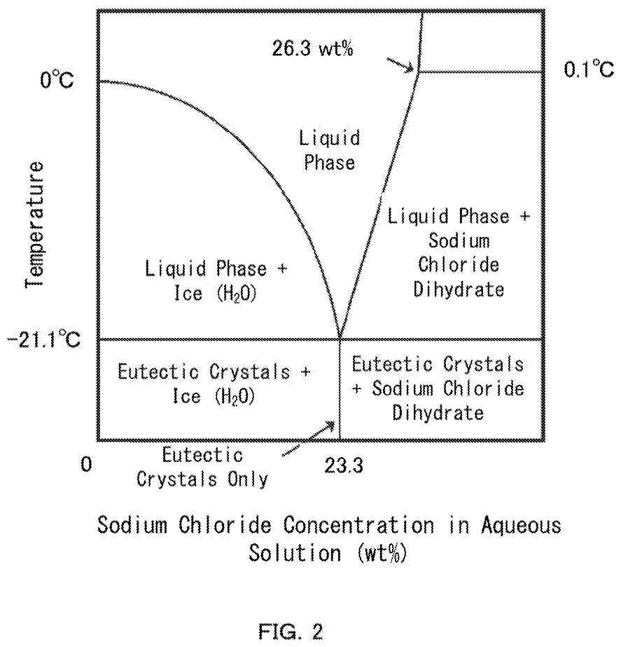

The aqueous solution of sodium chloride, which is a thermal storage base material for the latent heat storage material, contains a eutectic concentration of sodium chloride. Referring to the phase diagram in FIG. 2, the aqueous solution of sodium chloride exhibits a single melting point near −21° C. and a maximum amount of latent heat when the aqueous solution has a eutectic concentration (a concentration at which the aqueous solution forms only a eutectic mixture of water and the solute when solidified).

The latent heat storage material contains disodium hydrogen phosphate in an amount that, in comparison with the aqueous solution of sodium chloride having the eutectic concentration, is greater than or equal to an amount that gives a saturation concentration (against water) at 0° C. Disodium hydrogen phosphate, serving as a supercooling inhibitor, is required to unfailingly precipitate as crystals before reaching −21° C., which is the melting point of the aqueous solution of sodium chloride. Taking into an account the fact that the solvent is water and has a melting point of 0° C., the latent heat storage material should contain disodium hydrogen phosphate in an amount larger than or equal to the solubility of disodium hydrogen phosphate at 0° C. in order to unfailingly cause precipitation of disodium hydrogen phosphate.

Disodium hydrogen phosphate exhibits a low solubility in water at 0° C. Supercooling can be therefore restrained by adding disodium hydrogen phosphate in an amount that is slightly larger than or equal to the solubility at 0° C. In addition, disodium hydrogen phosphate forms a hydrate upon precipitating as crystals, but even a small amount thereof can achieve a supercooling inhibiting effect. The disodium hydrogen phosphate therefore takes away only a small amount of water from the aqueous solution in precipitation, thereby only marginally changing the base material concentration in the aqueous solution as will be described later in detail. In other words, the use of disodium hydrogen phosphate as a supercooling inhibitor in using an aqueous solution of sodium chloride having a eutectic concentration as a thermal storage base material for a latent heat storage material not only causes the onset temperature of solidification (solidification temperature) to approach the melting point, but also little affects the cold insulation temperature and time, thereby enabling maintaining a high cold insulation capability.

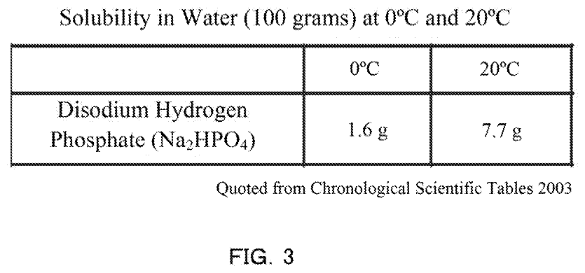

The latent heat storage material preferably contains disodium hydrogen phosphate in an amount that, in comparison with the aqueous solution of sodium chloride having the eutectic concentration, is less than or equal to an amount that gives a saturation concentration (in water) at 20° C. for the following reasons. The latent heat storage material containing disodium hydrogen phosphate in an amount less than or equal to an amount that gives a saturation concentration at 20° C. does not leave the disodium hydrogen phosphate undissolved or cause the disodium hydrogen phosphate to precipitate, at room temperature. The resultant aqueous solution is thus uniform. Additionally, as shown in FIG. 3, disodium hydrogen phosphate has a solubility that is almost 5 times higher at 20° C. than at 0° C. Disodium hydrogen phosphate can quickly dissolve at room temperature if its amount is less than or equal to the solubility at 20° C.

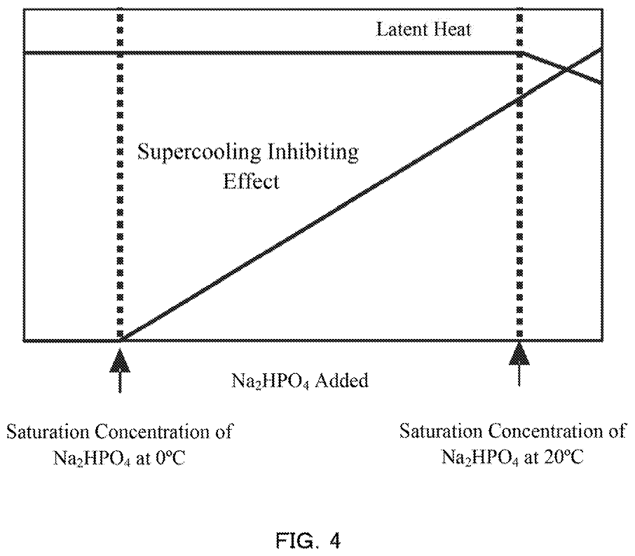

FIG. 4 is a conceptual drawing depicting the supercooling inhibiting effect and amount of latent heat per unit weight of disodium hydrogen phosphate. Referring to FIG. 4, the supercooling inhibiting effect improves with an increasing amount (weight) of disodium hydrogen phosphate added. In contrast, the amount of latent heat hardly decreases when disodium hydrogen phosphate is added. The latent heat storage material may therefore contain disodium hydrogen phosphate in any amount from an amount that gives a saturation concentration at 0° C. to an amount that gives a saturation concentration at 20° C., and the amount of disodium hydrogen phosphate may be specified in any suitable mariner in view of the balance between the cost of materials and the supercooling inhibiting effect.

### Changes in Concentration in Aqueous Solution

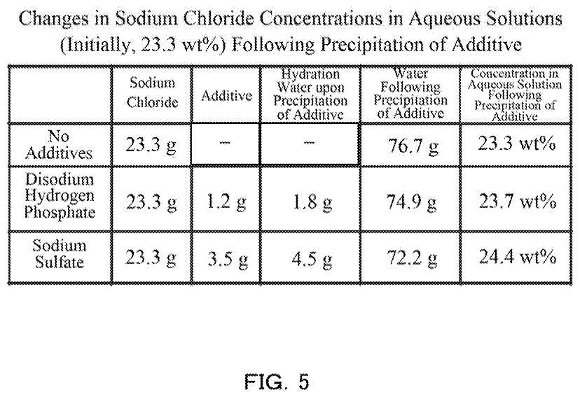

FIG. 5 is a table showing changes in sodium chloride concentrations that occurs when the additive precipitates in aqueous solutions initially having a eutectic concentration, under different conditions: no additive has been added, disodium hydrogen phosphate has been added, and sodium sulfate has been added, to the aqueous solution. To 100 grams of an aqueous solution of sodium chloride (76.7 grams of water) having a concentration of 23.3 wt %, which is a eutectic concentration, an additive is added in an amount equivalent to the solubility in 100 grams of water at 0° C.

Disodium hydrogen phosphate has a solubility of 1.6 grams in 100 grams of water at 0° C. Therefore, 1.2 grams (1.6 grams×76.7/100) of disodium hydrogen phosphate is added to 100 grams of a 23.3 wt % aqueous solution of sodium chloride (76.7 grams of water). If the added disodium hydrogen phosphate all precipitates as dodecahydrate, the resultant aqueous solution of sodium chloride has a concentration 23.7 wt %.

Sodium sulfate has a solubility of 4.5 grams in 100 grams of water at 0° C. Therefore, 3.5 grams (4.5 grams×76.7/100) of sodium sulfate is added to 100 grams of a 23.3 wt % aqueous solution of sodium chloride (76.7 grams of water). If the added sodium sulfate all precipitates as decahydrate, the resultant aqueous solution of sodium chloride has a concentration of 24.4 wt %. This post-precipitation concentration differs vastly from the eutectic concentration, thereby producing a large amount of sodium chloride dihydrate in addition to eutectic crystals upon cooling and reducing the latent heat generated at around −21° C.

It is hence understood that the use of disodium hydrogen phosphate as a supercooling inhibitor will lead to smaller changes in the concentration of the base material, therefore causing smaller decreases in the latent heat of the latent heat storage material, than does the use of sodium sulfate. Sodium sulfate and disodium hydrogen phosphate may be added in the form of decahydrate and dodecahydrate respectively and dissolved. In either of these cases, the aqueous solution has a lower concentration than the eutectic concentration, thereby forming ice upon cooling and decreasing the latent heat, unless all the added sodium sulfate or disodium hydrogen phosphate precipitates. Still, disodium hydrogen phosphate causes a smaller deviation from the eutectic concentration and smaller decreases in the latent heat because disodium hydrogen phosphate needs to be added in a smaller amount.

For these reasons, the disodium hydrogen phosphate to be added to the aqueous solution of sodium chloride having the eutectic concentration may be partially or entirely a hydrate. The discussion above shows that the amount of water may be adjusted in order to reduce the deviation from the eutectic concentration that occurs upon the precipitation of disodium hydrogen phosphate, for example, by adding disodium hydrogen phosphate in the form of a hydrate accounting for the amount in excess of the amount that gives the saturation concentration at 0° C., out of an amount greater than or equal to the amount that gives the saturation concentration at 0° C., or by adding an excess amount of water converted as a hydrate.

### EXAMPLES AND COMPARATIVE EXAMPLES

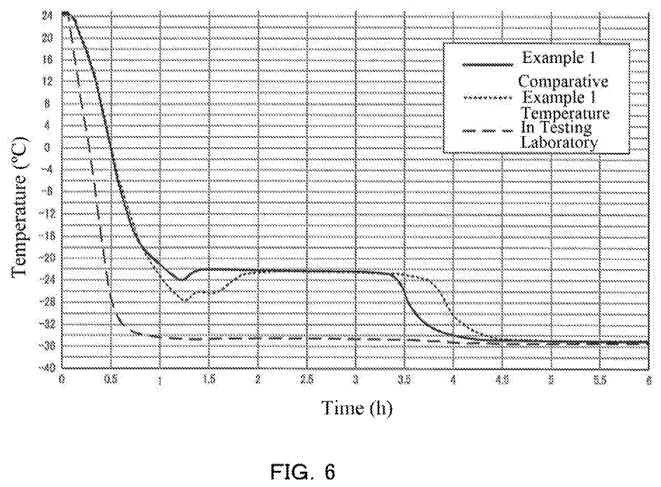

FIG. 6 is a graph representing results of measurement of the temperature of solutions during solidification using a thermocouple in a temperature-variable thermostatic chamber for Example 1 and Comparative Example 1. The sample solution for Comparative Example 1 was 50 grams of a 23 wt % aqueous solution of sodium chloride. The sample solution for Example 1 was an aqueous solution obtained by adding, to 50 grams of a 23 wt % aqueous solution of sodium chloride (same solution as for Comparative Example 1), anhydrous disodium hydrogen phosphate up to a concentration of 2.0 wt %, which is greater than or equal to the saturation concentration at 0° C. (taking the 23 wt % aqueous solution of sodium chloride as 100 wt %, anhydrous disodium hydrogen phosphate has a saturation concentration of 1.2 wt % at 0° C.). The temperature-variable thermostatic chamber was operated by running a temperature program with such settings that the temperature would fill from 25° C. to −35° C. over 1 hour and then stay at −35° C.

The graph shows, for Comparative Example 1, that the temperature fell to a minimum (onset temperature of solidification) of approximately −28° C. where supercooling stopped and that the aqueous solution subsequently solidified generating heat. The graph also shows, for Example 1, that the onset temperature of solidification was approximately −24° C. It is hence verified that the addition of disodium hydrogen phosphate restrains supercooling. Although solidification and melting were repeated more than once, solidification was still found stable.

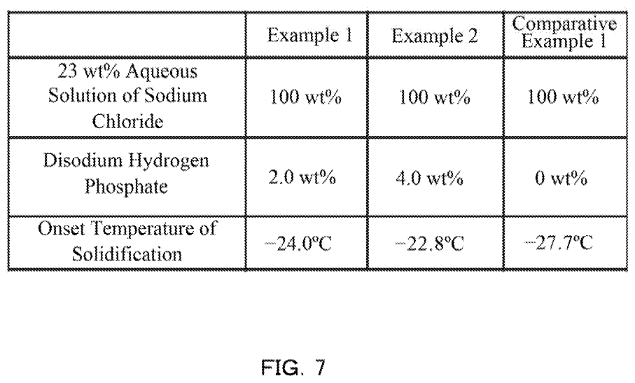

FIG. 7 is a table showing an onset temperature solidification for Examples 1 and 2 and Comparative Example 1. The data for Example 1 and Comparative Example 1 were obtained in experiments conducted under the conditions described above. The sample solution for Example 2 contained 4.0 wt % disodium hydrogen phosphate. The table shows that the onset temperature of solidification was 1.2° C. higher in Example 2 than in Example 1. It is hence verified that the increased amount of disodium hydrogen phosphate added can enhance the supercooling inhibiting effect. This is because the increased added amount increases the precipitation of disodium hydrogen phosphate upon cooling, facilitating the formation of nuclei by the base material.

It is hence verified that the 23 wt % aqueous solution of sodium chloride solidifies in a stable manner when the aqueous solution contains, as a supercooling inhibitor, disodium hydrogen phosphate in an amount greater than or equal to the amount that gives the saturation concentration at 0° C. and also that the increased amount of disodium hydrogen phosphate added raises the onset temperature of solidification and enhances the supercooling inhibiting effect.

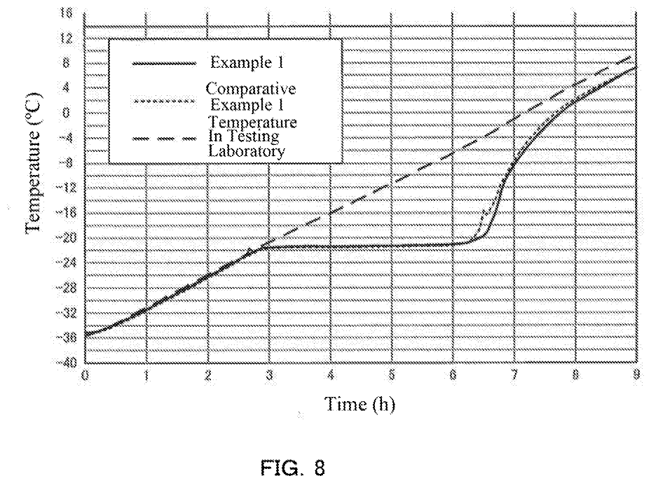

FIG. 8 is a graph representing results of measurement of the temperature of solutions during melting using a thermocouple in a temperature-variable thermostatic chamber for Example 1 and Comparative Example 1. The temperature-variable thermostatic chamber was operated by running a temperature program with such settings that the temperature would rise at a rate of 5° C./h starting from −35° C.

The graph shows, for both Example 1 and Comparative Example 1, that the period during which the temperature of the solution remained constant due to heat absorption (from 3 to 6.5 hours into the experiment) coincided with melting and that the temperature remained constant at approximately −21° C. It is hence verified that the addition of disodium hydrogen phosphate little affects the melting point. The graph also shows that the time taken by complete melting before the temperature started to rise with the rising internal temperature of the test chamber differed little between Example 1 and Comparative Example 1. It is hence verified that the addition of disodium hydrogen phosphate hardly reduces the latent heat.

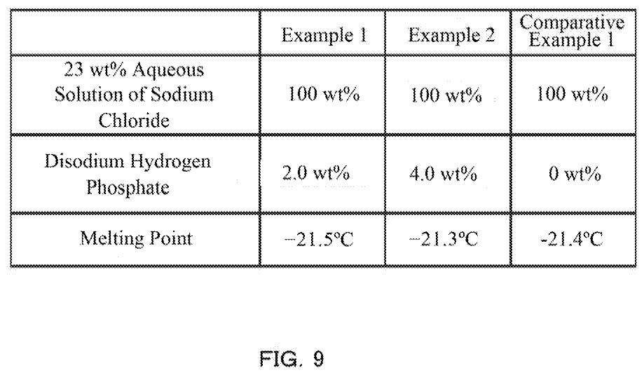

FIG. 9 is a table showing a melting point for Examples 1 and 2 and Comparative Example 1. Data were obtained in experiments conducted under the conditions described above. It is hence verified that the addition of disodium hydrogen phosphate up to 4.0 wt % little changes the melting point and does not affect the melting point of the base material.

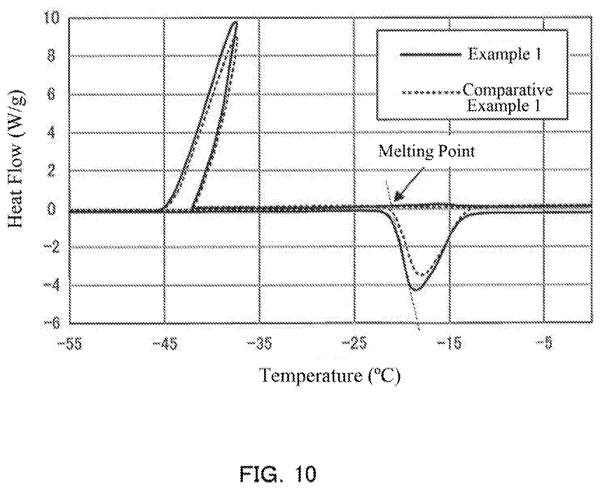

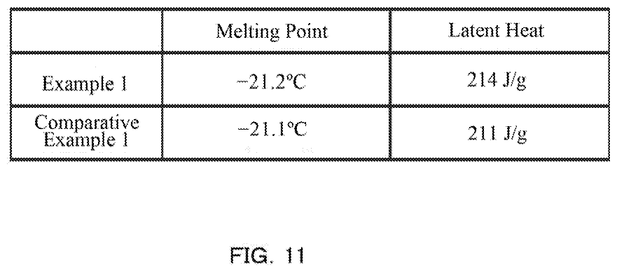

FIG. 10 is a graph representing results of DSC measurement for Example 1 and Comparative Example 1. FIG. 11 is a table showing a melting point and the amount of latent heat generated during melting for Example 1 and Comparative Example 1, obtained from the results of measurement shown in FIG. 10. Settings were made in a temperature program for DSC measurement such that the temperature would fall from 30° C. to −55° C. at a rate of 5° C./min, stay at −55° C. for 5 minutes, and then rise at a rate of 5° C./min to 30° C.

The peak in the negative heat flow domain near −20° C. corresponds to heat absorption due to melting in both Example 1 and Comparative Example 1. The melting point was obtained from the intersection of the baseline and the tangent on the lower temperature side of the peak. The table lists practically the same melting point for Example 1 and Comparative Example 1. It is hence verified that the addition of disodium hydrogen phosphate little affects the melting point.

The amounts of latent heat generated during melting as obtained from the area of the melting peaks hardly differ between Example 1 and Comparative Example 1. Rather, Example 1, where disodium hydrogen phosphate was added, exhibited a greater amount of latent heat, which verifies that the addition of disodium hydrogen phosphate does not reduce the amount of latent heat.

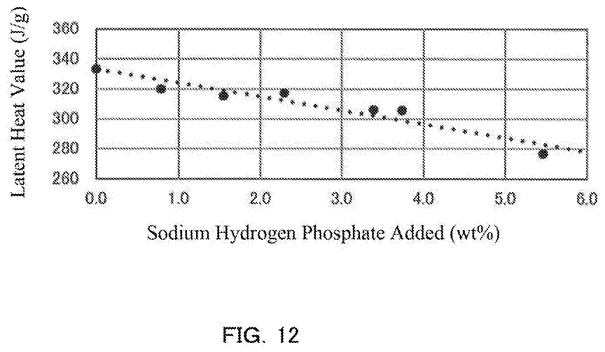

FIG. 12 is a graph representing results of DSC measurement of a latent heat value in Comparative Example 2 where anhydrous disodium hydrogen phosphate was added to water (water: 100 wt %). In Comparative Example 2, the latent heat value decreases with an increase in the amount of disodium hydrogen phosphate added, which verifies that even the addition of disodium hydrogen phosphate to the aqueous solution of sodium chloride does not reduce the amount of latent heat.

Since the aqueous solution of sodium chloride having the eutectic concentration does not form ice or precipitate sodium chloride dihydrate, but forms only eutectic crystals of water and sodium chloride upon cooling, the graph shows no heat absorption peaks that would otherwise be caused by a reduction thereof. FIG. 10 therefore shows only one peak, which is attributable to the formation of eutectic crystals, for Comparative Example 1. FIG. 10 likewise shows only one peak for Example 1. It is hence verified that the concentration is hardly changed by the generation of a disodium hydrogen phosphate hydrate and remains near the eutectic concentration.

### Structure of Cold Storage Pack

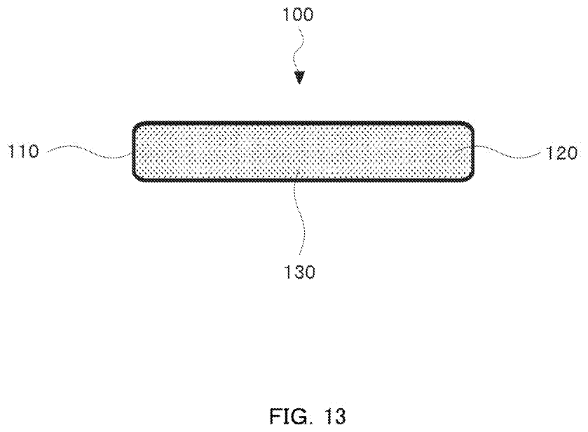

A cold storage pack in accordance with the present invention is for cooling an object to be kept cold and includes: the aforementioned latent heat storage material; and a container section containing the latent heat storage material. FIG. 13 is a cross-sectional view of an exemplary cold storage pack 100 in accordance with the present embodiment. Referring to FIG. 13, the cold storage pack 100 in accordance with the present embodiment includes: a hollow container section 120 inside a cold storage pack main body 110; and a thermal storage layer 130 in the container section 120.

The cold storage pack main body 110 includes the hollow container section 120 for encasing the thermal storage layer 130. The cold storage pack main body 110 may be made of a resin material such as polyethylene, polypropylene, polyester, polyurethane, polycarbonate, polyvinyl chloride, or polyamide, a metal such as aluminum, stainless steel, copper, or silver, or an inorganic material such as glass or ceramics. The cold storage pack main body 110 is preferably made of a resin material for durability and ease in manufacturing the hollow structure. The cold storage pack main body 110 may be encased in a film made primarily of polyethylene, polypropylene, polyester, polyurethane, polycarbonate, polyvinyl chloride, or polyamide. The film may be provided with a thin film of aluminum or silicon dioxide for enhanced durability and barrier properties of the film. The cold storage pack main body 110 preferably has a sticker made of a thermochromic substance attached thereonto to indicate its temperature so that a user can know of the temperature of the cold storage pack.

The thermal storage layer 130 contains a latent heat storage material 150 in accordance with the present embodiment. In addition, the thermal storage layer 130 preferably has a preservative or an antibacterial agent added to a component material thereof. The thermal storage layer 130 may also has a thickening agent, such as xanthan gum, guar gum, carboxy methyl cellulose, or sodium polyacrylate, added to a component material thereof. The component materials for the present invention are not limited to these examples.

The latent heat storage material 150 contains an aqueous solution of sodium chloride having the eutectic concentration as a thermal storage base material and hence has a single melting point near −21° C. The latent heat storage material 150 further contains disodium hydrogen phosphate as a supercooling inhibitor to adjust the solidification temperature thereof. The latent heat storage material 150 can be hence solidified in a household freezer or like common cooling device.

### Method of Manufacturing Cold Storage Pack

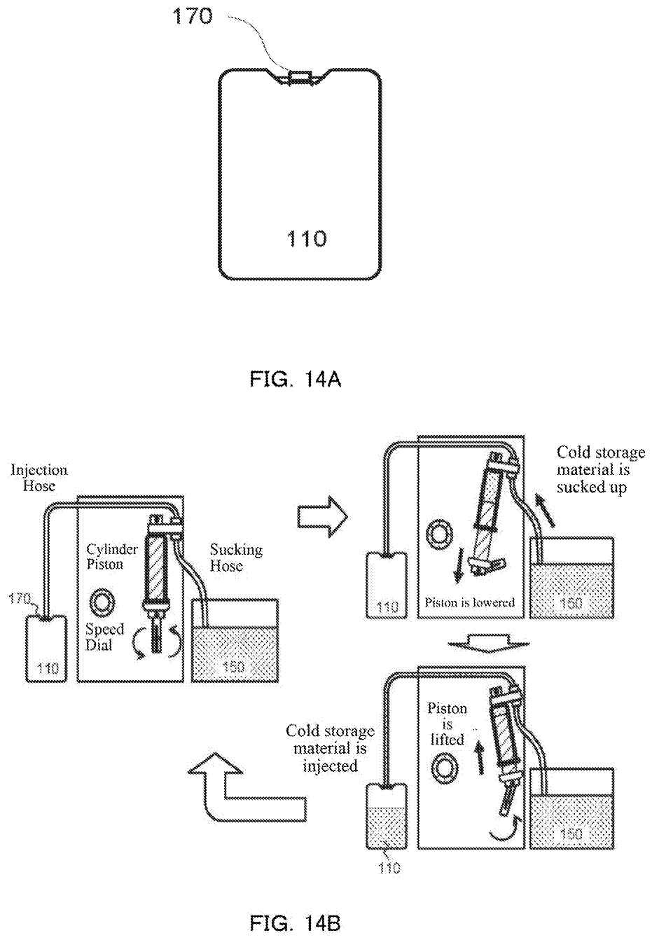

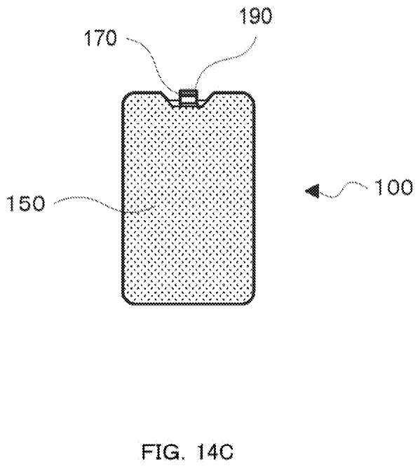

A description will be given next of a method of manufacturing the cold storage pack 100 in accordance with the present embodiment. FIGS. 14A to 14C are conceptual drawings illustrating manufacturing steps for the cold storage pack 100 in accordance with the present embodiment. First, as shown in FIG. 14A, a hollow cold storage pack main body 110 is prepared. The cold storage pack main body 110 preferably has an injection hole 170 through which the latent heat storage material 150 may be injected. Next, the latent heat storage material 150 is injected. The latent heat storage material 150 may be injected by any method and is preferably injected using a cylinder pump or a Mohno pump. FIG. 14B shows an example using a cylinder pump. Referring to FIG. 14B, an injection hose of the cylinder pump is attached to the injection hole 170 of the cold storage pack main body 110, and a sucking hose of the cylinder pump is attached to the container containing the latent heat storage material 150. Next, the latent heat storage material 150 is sucked up by lowering a piston of the cylinder pump, to pour the thermal storage material into the piston. The piston is then lifted to inject the latent heat storage material 150 into the cold storage pack main body 110.

Then, as shown in FIG. 14C, the injection hole 170 of the cold storage pack main body 110 is closed with a plug 190. The plug 190 may seal the injection hole 170 by a conventional technique such as ultrasonic welding or thermal welding and may be a screw plug for the user to freely open/close the hole by hand. Ultrasonic or thermal welding-based sealing is preferred because the latent heat storage material 150 is inhibited from leaking.

Finally, the cold storage pack 100 is left in an environment where temperature is at or below the solidification temperature of the latent heat storage material 150, to solidify the latent heat storage material 1500. The cold storage pack 100 in accordance with the present embodiment is manufactured by these steps. The latent heat storage material 150 may be solidified before the cold storage pack 100 is used as described here. Alternatively, if the cold storage pack 100 is used in a cooling container or logistic packaging container (detailed later) and can be cooled while in use to or below the solidification temperature of the latent heat storage material 150, the latent heat storage material 150 in the cold storage pack 100 may be solidified in such an environment. The technical scope of the present invention is not necessarily limited to these embodiments and may be modified in various ways without departing from the scope of the present invention.

### Second Embodiment

### Structure of Cooling Container

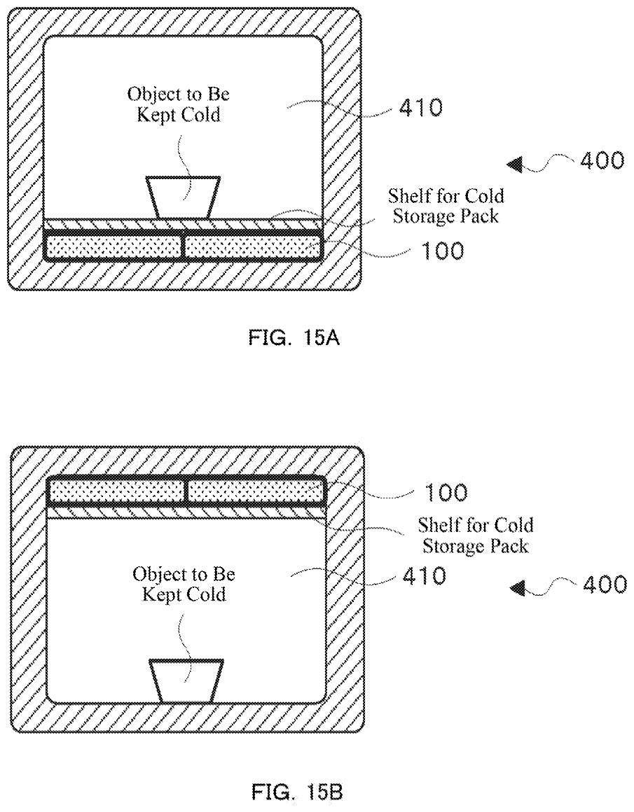

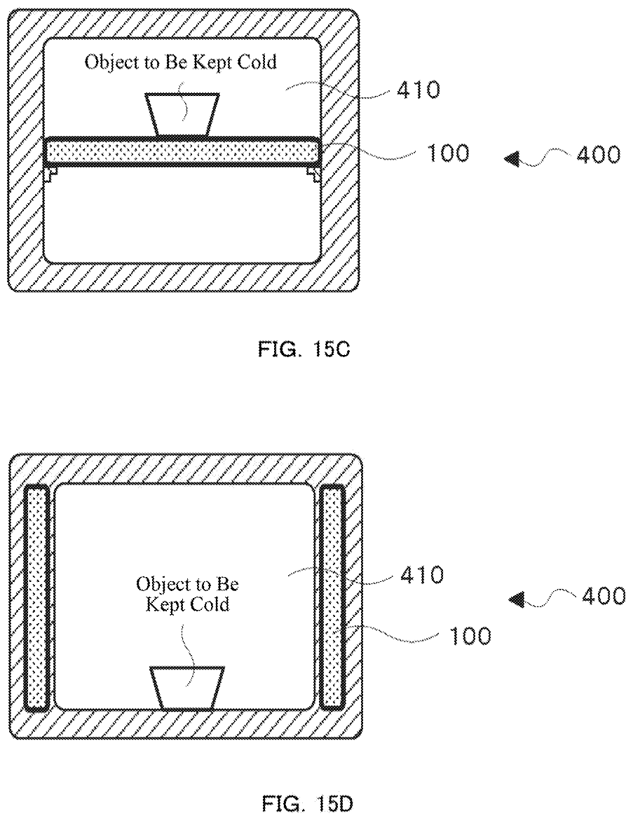

The present embodiment is an application to a cooling container of the cold storage pack in accordance with the first embodiment. FIG. 15A is a cross-sectional view of an exemplary cooling container 400 in accordance with the present embodiment. The cooling container 400 includes a refrigerator compartment 410 and a cold storage pack 100 in accordance with the first embodiment. The cooling container 400 further includes an electric cooling device for cooling the refrigerator compartment (not shown) and has a control temperature at which at least the cold storage pack 100 can be frozen.

The refrigerator compartment 410 is disposed inside the cooling container 400 to house therein an object to be kept cold. In this structure, the object is kept at low temperature by the electric cooling device when there is a power supply available and by latent and sensible heat of the latent heat storage material 150 in the cold storage pack 100 when the power supply is disrupted. The refrigerator compartment 410 preferably has a thermal insulation material provided on the inner and outer walls or inside the walls.

The cold storage pack 100 is disposed in the refrigerator compartment 410. Alternatively, there may be provided a plurality of cold storage packs 100. FIGS. 15B to 15D are cross-sectional views of a variation example of the cooling container 400 in accordance with the present embodiment. The cold storage pack 100 may be disposed on an internal wall of the refrigerator compartment 410 or inside that wall. The cold storage pack 100 may be positioned to face a shelf on which the object is placed or may by itself serve as a shelf on which the object is placed.

When there is a power supply available, the cold storage pack 100 solidifies as the temperature of the refrigerator compartment 410 is lowered. When the power supply is disrupted, the latent heat storage material 150 in the cold storage pack 100 melts and absorbs heat in response to the rising temperature of the refrigerator compartment 410, thereby maintaining the inside of the refrigerator compartment 410 at or below −18° C. The latent heat storage material 150 in the cold storage pack 100 has a large latent heat value and is therefore capable of maintaining the inside of the refrigerator compartment 410 at or below −18° C. for an extended period of time even when the power supply is disrupted.

The cooling container 400 is preferably capable of cooling the inside of the refrigerator compartment 410 to or below −24° C. by supplying to the inside the air electrically cooled by the electric cooling device. If the inside of the refrigerator compartment 410 can be cooled down to or below −24° C., the cold storage pack 100 can be sufficiently solidified in the refrigerator compartment 410 even if the cold storage pack 100 containing a liquid latent heat storage material 150 is placed in the refrigerator compartment 410. The cold storage pack 100 can he solidified at temperatures higher than that temperature, depending on an adjusted solidification temperature of the latent heat storage material 150.

### Third Embodiment

### Structure of Logistic Packaging Container

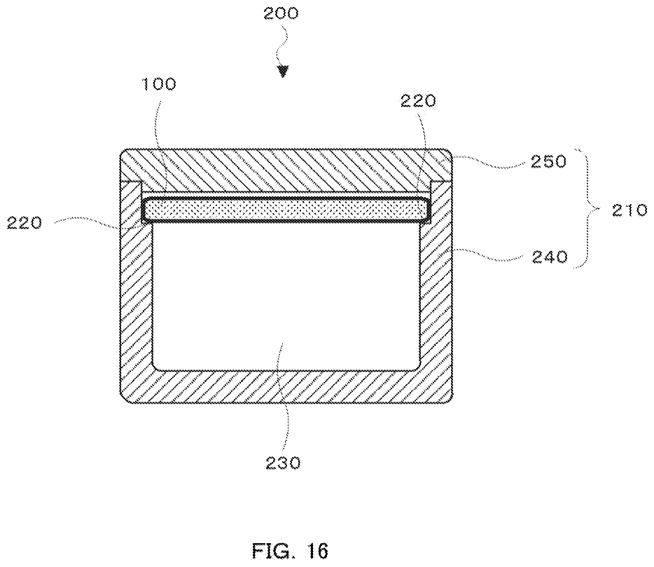

The present embodiment is an application to a logistic packaging container of the cold storage pack in accordance with the first embodiment. FIG. 16 is a cross-sectional view of an exemplary logistic packaging container 200 in accordance with the present embodiment. The logistic packaging container 200 includes: a logistic packaging container body 210; a cold-insulation-pack-holding section 220 disposed inside the logistic packaging container body 210 to hold the cold storage pack 100; the cold storage pack 100; and an article housing section 230 disposed inside the logistic packaging container body 210 to house an article (object to be kept cold)0.

The logistic packaging container body 210 includes a container section 240 and a lid section 250. The container section 240 has an opening through which the article and the cold storage pack 100 are taken out of, and put into, the container section 240. The lid section 250 closes the opening. The container section 240 and the lid section 250 may be either coupled or separated. The lid section 250 is preferably structured so as to tightly seal the container section 240 in order to restrict the flow of heat into and out of the logistic packaging container 200.

The logistic packaging container body 210 is preferably made of a thermal insulating material such as styrene foam, urethane foam, or a vacuum insulation material. Alternatively, the logistic packaging container body 210 may include: a main body made of a material that may not be thermally insulating; and a thermal insulation layer made of a thermal insulating material and disposed inside or outside the main body. The logistic packaging container body 210 may be either so sized that a person can carry it around or built with very large dimensions like, for example, a shipping container. Alternatively, the logistic packaging container 200 may be built as a container equipped with a cooling device like a reefer container.

The cold-insulation-pack-holding section 220 disposed inside the logistic packaging container body 210. When the logistic packaging container 200 is used, the cold storage pack 100 is placed in or on the cold-insulation-pack-holding section 220. The internal space of the logistic packaging container body 210 is hence maintained at or below −18° C. The cold-insulation-pack-holding section 220 may be structured so as to fix the cold storage pack 100. The cold storage pack 100 may be incorporated into the logistic packaging container body 210. The cold storage pack 100 may function as the logistic packaging container 200 on its own.

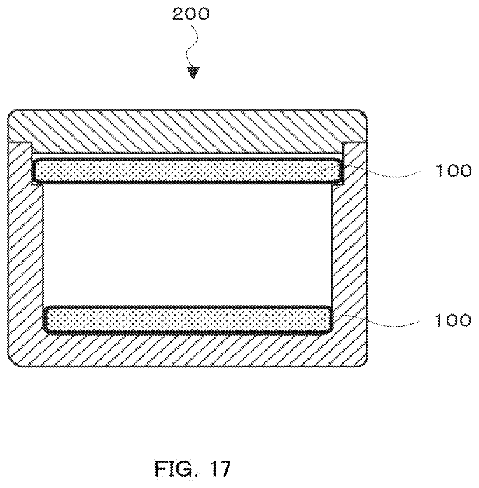

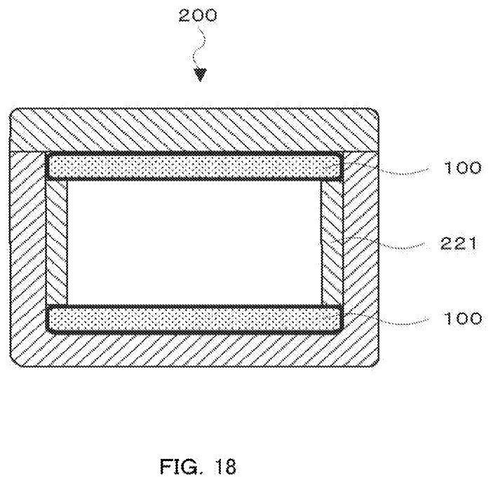

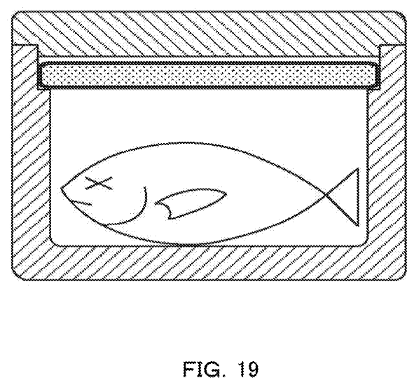

The article housing section 230 is placed inside the logistic packaging container body 210 and houses an article to be kept at or below −18° C. This structure enables the article to be kept at or below −18° C. FIGS. 17 and 18 are cross-sectional views of variation examples of the logistic packaging container 200 in accordance with the present embodiment. Referring to FIGS. 17 and 18, there may be provided a plurality of cold storage packs 100. The cold storage packs 100 may be supported by a cold-insulation-pack-holding member 221 as shown in FIG. 18. FIG. 19 is a conceptual drawing illustrating how the logistic packaging container 200 in accordance with the present embodiment is used. When the cold storage pack 100 and the logistic packaging container 200 in accordance with the present embodiment are used, the article and the cold storage pack 100 are packaged in the logistic packaging container 200 as shown in FIG. 19.

### Fourth Embodiment

### Structure of Cooling Unit

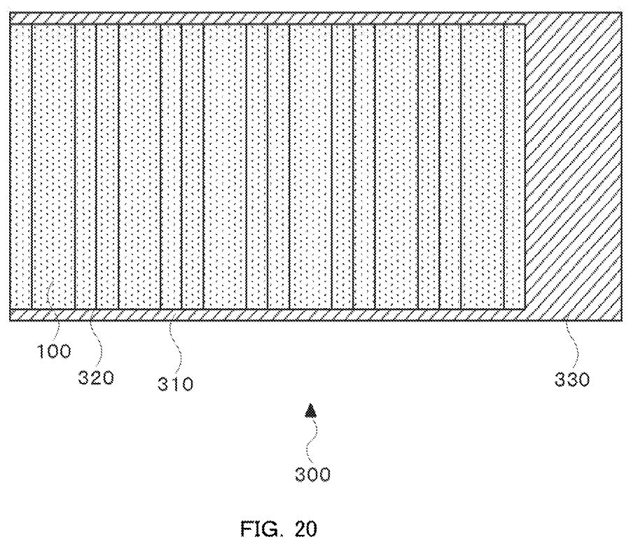

The present embodiment is an application of a plurality of cold storage packs in accordance with the first embodiment to a cooling unit. FIGS. 20 to 23 are schematic illustrations of an exemplary cooling unit 300 in accordance with the present embodiment. The cooling unit 300 in accordance with the present embodiment includes a plurality of cold storage packs 100 in accordance with the first embodiment and a cold-storage-pack holder 310.

The cold storage packs 100 are formed like strips. The cold storage packs 100 have a trapezoidal cross-section in FIGS. 20 to 23, but may have a different shape. For instance, when the object to be kept cold is a cylindrical can, the cold storage packs 100 may be formed so as to have a curved face where the cold storage packs 100 come into contact with the object, in order to increase the contact area. The thickness in the direction of a longer side may be changed so as to fit, for example, a wine bottle, FIGS. 20 to 23 show six cold storage packs 100 being used as an example. Any number of cold storage packs 100 may be used that matches the object to be kept cold in the cooling unit 300.

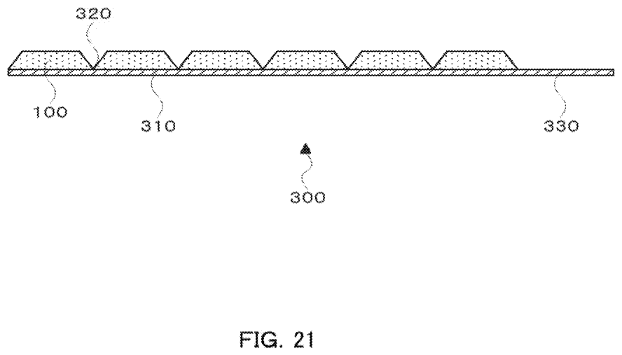

The cold storage packs 100 may include articulation mechanisms 320 attached to adjoining cold storage packs 100. This structure integrates the cold storage packs 100 into a single body and still provides flexibility, thereby enhancing operability when the cold storage packs 100 are placed around an object to be kept cold. The connected cold storage packs 100 are placed around in contact with an object to be kept cold, and the cold-storage-pack holder 310, which has such dimensions as to cover the outer circumference thereof, is wrapped around in order to fix the cold storage packs 100. In this structure, the cold-storage-pack holder 310, which fixes the cold storage packs 100, is preferably made of a flexible material, FIGS. 20 and 21 show the cold storage packs 100 including the articulation mechanisms 320 attached to adjoining cold storage packs 100.

The cold-storage-pack holder 310 is placed around the cold storage packs 100 and holds the cold storage packs 100 together either in proximity to or contact with an object to be kept cold. The cold-storage-pack holder 310 may be independent from the cold storage packs 100, may be alternatively so structured as to be detachable from the cold storage packs 100, and may be, as a further alternative, fixed to the cold storage packs 100 to form an integral body. When the cold storage packs 100 are independent or detachable, the number of the cold storage packs 100 used may be altered in accordance with the circumference of the portion of the object on which the cooling unit 300 is placed. When the cold storage packs 100 are independent or detachable, the cold storage packs 100 can be exclusively cooled to or below the solidification temperature thereof and solidified.

The cold-storage-pack holder 310 is preferably made of a thermal insulating material such as polyethylene foam, urethane foam, or glasswool, to prevent heat exchange with the open air. The cold-storage-pack holder 310 may have one of the two sides thereof made of a material that may or may not be thermally insulating and the other side thereof made of a thermal insulating material.

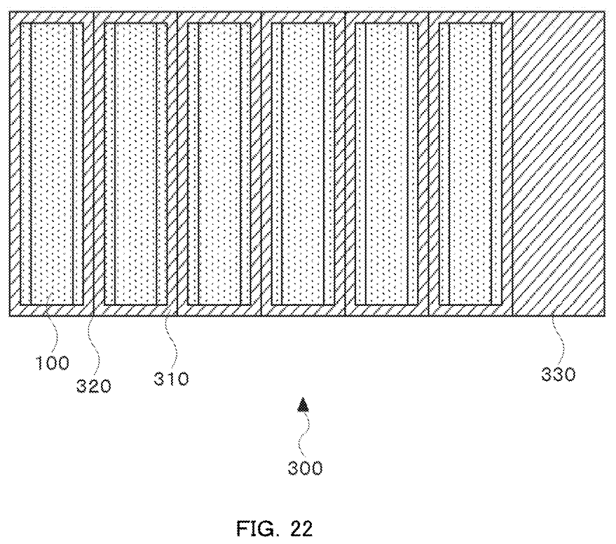

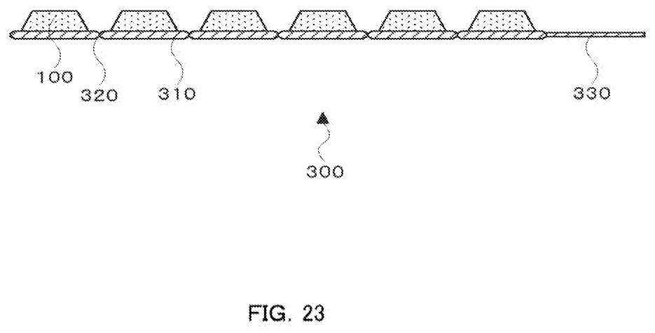

The cold-storage-pack holder 310 may include the articulation mechanisms 320 coupling adjoining cold storage packs 100. This structure integrates the cold storage packs 100 into a single body and still provides flexibility, thereby enhancing operability when the cold storage packs 100 are placed around an object to be kept cold, even if the cold storage packs 100 include no articulation mechanisms 320. FIGS. 22 and 23 show the cold-storage-pack holder 310 being made of a plurality of platelike components and including the articulation mechanisms 320 where the platelike components meet. If the cold-storage-pack holder 310 is made of a flexible material, the articulation mechanisms 320 may be alternatively provided by the flexibility of the material. As a further alternative, both the cold storage packs 100 and the cold-storage-pack holder 310 may include the articulation mechanisms 320.

The cold-storage-pack holder 310 may be planar and wrapped around an object to be kept cold when the cooling unit 300 is placed around the object. This structure preferably includes a fixing mechanism 330 such that the cooling unit 300 can be fixed in any position in accordance with the length of the portion of the object on which the cooling unit 300 is placed. The fixing mechanism 330 may be, for example, a hook and loop fastener, in which case the cold-storage-pack holder 310 preferably has either one or both of the ends thereof made of a flexible material.

The cold-storage-pack holder 310 may be cylindrical so that an object to be kept cold can be put into the cylindrical pocket formed by the cooling unit 300 instead of placing the cooling unit 300 around the object. In this structure, to make the cold-storage-pack holder 310 afford to adjust to a certain range of object sizes, the cold-storage-pack holder 310 is preferably made at least partially of an elastic material. This elastic structure exerts elastic force bringing the cold storage packs 100 into contact with objects having a range of sizes. The structure is realized, for example, if the articulation mechanisms 320 are made of rubber.

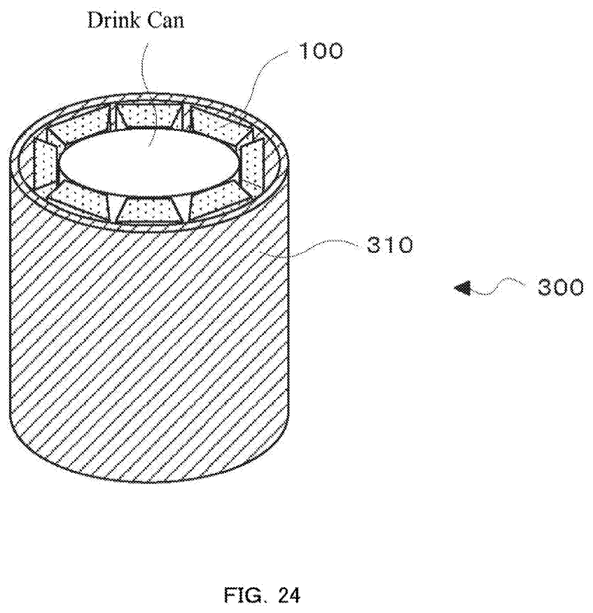

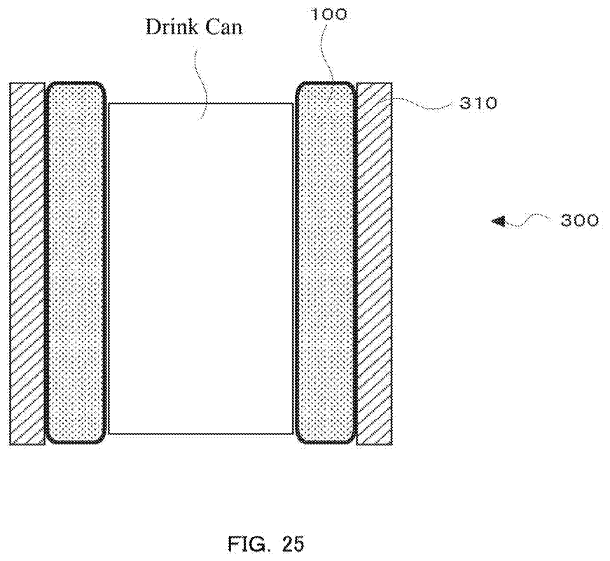

FIG. 24 is a conceptual drawing illustrating an example of how the cooling unit 300 in accordance with the present embodiment is used. FIG. 25 is a cross-sectional view of an example of how the cooling unit 300 in accordance with the present embodiment is used. Referring to FIGS. 24 and 25, the cold storage packs 100 is brought into proximity to or contact with an object to be kept cold by placing the cooling unit 300 around the object. The object can be hence rapidly cooled even when the object and the cold storage packs in the cooling unit have different temperatures.

### Fifth Embodiment

### Composition of Latent Heat Storage Material

A latent heat storage material in accordance with the present embodiment contains an inorganic salt and water as a base material. The inorganic salt includes at least sodium chloride. The inorganic salt and the water form a eutectic mixture. The latent heat storage material contains disodium hydrogen phosphate in an amount that, in comparison with the base material, is greater than or equal to an amount that gives a saturation concentration at a temperature at which the eutectic mixture melts.

The base material of the latent heat storage material is composed of an inorganic salt and water. The inorganic salt includes at least sodium chloride. In other words, the base material of the latent heat storage material is composed of sodium chloride, another inorganic salt, and water and is an aqueous solution of at least sodium chloride and optionally another inorganic salt or other inorganic salts. The inorganic salt(s) and the water form a eutectic mixture. In other words, the sodium chloride, the other inorganic salt(s), and the water form a eutectic mixture.

The inorganic salt other than sodium chloride is preferably ammonium chloride, potassium chloride, lithium chloride, magnesium chloride, calcium chloride, sodium bromide, potassium bromide, sodium sulthte, potassium sulfate, magnesium sulfate, calcium sulfate, sodium hydrogen sulfate, potassium hydrogen sulfate, sodium carbonate, potassium carbonate, sodium hydrogen carbonate, or potassium hydrogen carbonate. Chloride salts such as ammonium chloride and potassium chloride are particularly preferred because they dissolve in water and generate chloride ions, which are the same species as the chloride ions generated by sodium chloride where no anionic species exchange occurs. Likewise, sodium salts such as sodium bromide are particularly preferred because they dissolve in water and generate sodium ions, which are the same species as the sodium ions generated by sodium chloride where no cationic species exchange occurs.

Since the sodium chloride, other inorganic salt, and water in the base material of the latent heat storage material form a eutectic mixture as described above, the latent heat storage material has a melting point that is not −21° C., which is the melting point the eutectic mixture of sodium chloride and water. For instance, the eutectic mixture of ammonium chloride and water and the eutectic mixture of potassium chloride and water have respective melting points of approximately −15° C. and approximately −11° C. A melting point below −21° C. becomes feasible by these inorganic salt, sodium chloride, and water forming a eutectic mixture. In addition, because the melting point of the eutectic mixture of these inorganic salts and water differs from the melting point of the eutectic mixture of sodium chloride and water by approximately 10° C., which is small, the eutectic mixture of these inorganic salts and water will likely form), and the melting point is easily adjustable. Furthermore, the eutectic mixture of ammonium chloride and water has a latent heat value of approximately 290 J/g. The eutectic mixture of potassium chloride and water has a latent heat value of approximately 300 J/g. These latent heat values are higher than the latent heat value of the eutectic mixture of sodium chloride and water (approximately 220 J/g). The eutectic mixture of sodium chloride, either ammonium chloride or potassium chloride, and water often has a higher latent heat value than the eutectic mixture of sodium chloride and water. The latent heat storage material may contain either only one inorganic salt or two or more inorganic salts other than sodium chloride from the viewpoint of adjusting the melting point and the latent heat value.

A eutectic crystal as used in the present invention is a crystalline composition that melts at a single temperature in a phase transition of a plurality of compounds from the solid phase to the liquid phase. The eutectic crystal melts at a temperature (melting point) that differs from the melting points of the individual compounds. The melting at a single temperature can be verified by DSC measurement where a solid latent heat storage material, when heated, exhibits a single peak attributable to heat absorption. In addition, since the latent heat storage material in accordance with the present invention is an aqueous solution of sodium chloride and another inorganic salt when it is in the liquid phase, the latent heat storage material may be referred to simply as the aqueous solution of an inorganic salt(s). Furthermore, the concentration of an inorganic salt in water at which the inorganic salt and water form a eutectic mixture may be referred to as the eutectic concentration.

The latent heat storage material contains disodium hydrogen phosphate in an amount greater than or equal to an amount that gives a saturation concentration at a temperature at which the eutectic mixture melts. The disodium hydrogen phosphate, serving as a supercooling inhibitor, is required to, when the liquid latent heat storage material is cooled, precipitate as crystals before reaching the temperature at which the eutectic mixture melts. Therefore, supercooling is restrained if the disodium hydrogen phosphate is contained in an amount greater than or equal to an amount that gives a saturation concentration at a temperature at which the eutectic mixture melts. More preferably, if the disodium hydrogen phosphate is contained in an amount greater than or equal to an amount that gives a saturation concentration at 0° C., the disodium hydrogen phosphate unfailingly precipitates.

Disodium hydrogen phosphate exhibits a low solubility in water at 0° C. Supercooling can be therefore restrained by adding disodium hydrogen phosphate in an amount that is slightly larger than or equal to the solubility at 0° C. In addition, disodium hydrogen phosphate forms a hydrate upon precipitating as crystals, but even a small amount thereof can achieve a supercooling inhibiting effect. The disodium hydrogen phosphate therefore takes away only a small amount of water from the aqueous solution in precipitation, thereby only marginally changing the inorganic salt concentration in the aqueous solution. Furthermore, because the precipitated disodium hydrogen phosphate facilitates the formation of nuclei by the base material, not only can the onset temperature of solidification (solidification temperature) he moved closer to the melting point, but the cold insulation temperature and time are not much affected, and a high cold insulation capability can be maintained.

The latent heat storage material preferably contains disodium hydrogen phosphate in an amount that, in comparison with the base material, is less than or equal to an amount that gives a saturation concentration at 20° C. for the following reasons. The latent heat storage material containing disodium hydrogen phosphate in an amount less than or equal to an amount that gives a saturation concentration at 20° C. does not leave the disodium hydrogen phosphate undissolved or cause the disodium hydrogen phosphate to precipitate, at room temperature. The resultant aqueous solution is thus uniform.

The latent heat storage material may therefore contain disodium hydrogen phosphate in any amount from an amount that gives a saturation concentration at a temperature at which the base material melts to an amount that gives a saturation concentration at 20° C., and the amount of disodium hydrogen phosphate may be specified in any suitable manner in view of the balance between the cost of materials and the supercooling inhibiting effect.

### EXAMPLES AND COMPARATIVE EXAMPLES

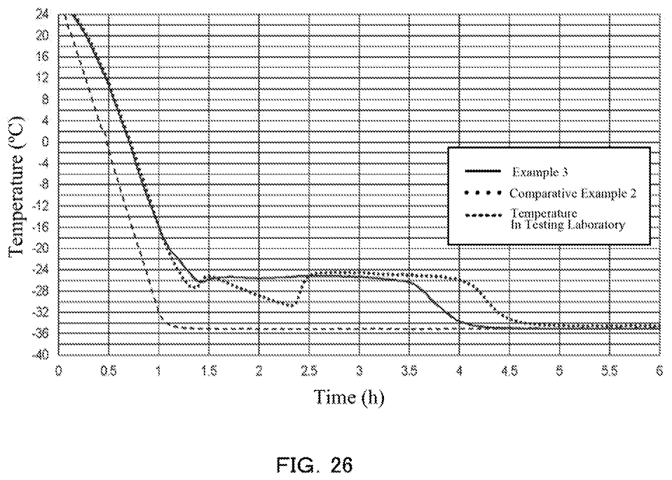

FIG. 26 is a graph representing results of measurement of the temperature of solutions during solidification using a thermocouple in a temperature-variable thermostatic chamber for Comparative Example 2 and Example 3. The sample solution for Comparative Example 2 was 50 grams of an aqueous solution containing 20 wt % sodium chloride and 5 wt % ammonium chloride. The sample solution for Example 3 was an aqueous solution obtained by adding, to 50 grams of an aqueous solution containing 20 wt % sodium chloride and 5 wt % ammonium chloride (same solution as for Comparative Example 2), anhydrous disodium hydrogen phosphate up to a concentration of 1.4 wt %, which is greater than or equal to the saturation concentration at −24° C. at which a eutectic mixture of sodium chloride, ammonium chloride, and water melts. The temperature-variable thermostatic chamber was operated by running a temperature program with such settings that the temperature would fall from 25° C. to −35° C. over 1 hour and then stay at −35° C.

The graph shows, for Comparative Example 2, that the temperature fell to a minimum (onset temperature of solidification) of approximately −31° C. where supercooling stopped and that the aqueous solution subsequently solidified generating heat. The graph also shows, for Example 3, that the onset temperature of solidification was approximately −26° C. It is hence verified that the addition of disodium hydrogen phosphate restrains supercooling. Although solidification and melting were repeated more than once, solidification was still found stable.

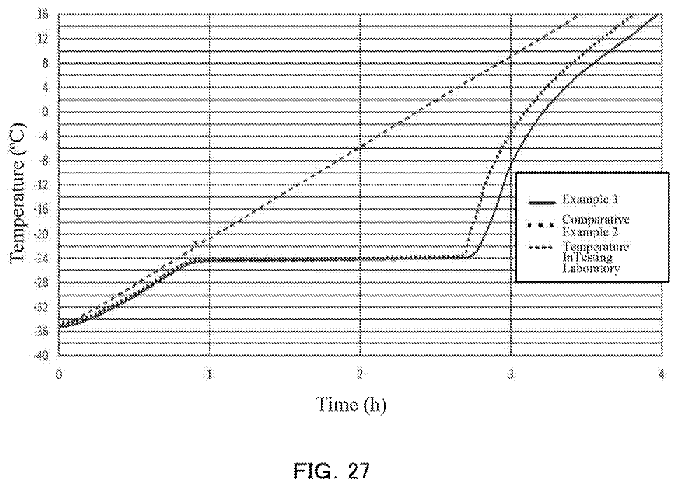

FIG. 27 is a graph representing results of measurement of the temperature of solutions during melting using a thermocouple in a temperature-variable thermostatic chamber for Example 3 and Comparative Example 2. The temperature-variable thermostatic chamber was operated by running a temperature program with such settings that the temperature would rise at a rate of 15° C./h starting from −35° C.

The graph shows, for both Example 3 and Comparative Example 2, that the temperature of the solution remaining constant due to heat absorption (from 0.8 hours to 2.8 hours into the experiment) coincided with melting and that the temperature remained at approximately −24° C. It is hence verified that the addition of disodium hydrogen phosphate little affects the melting point. The graph also shows that immediately after complete melting, the temperature started to rise with the rising internal temperature of the test chamber. It is hence verified that the addition of disodium hydrogen phosphate hardly reduces the latent heat.

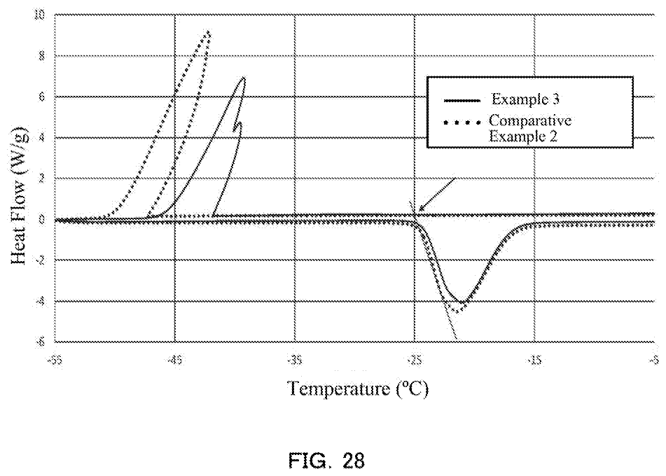

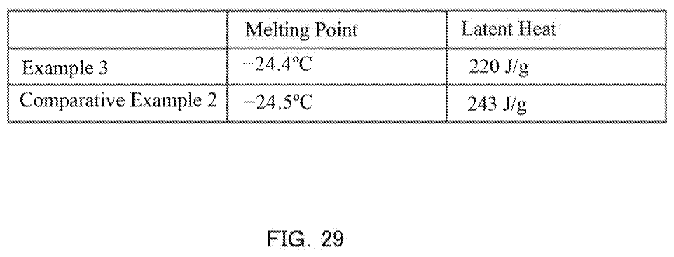

FIG. 28 is a graph representing results of DSC measurement for Example 3 and Comparative Example 2. FIG. 29 is a table showing a melting point and the amount of latent heat generated during melting for Example 3 and Comparative Example 2, as determined from the results of measurement shown in FIG. 28. Settings were made in a temperature program for DSC measurement such that the temperature would fall from 30° C. to −55° C. at a rate of 5° C./min, stay at −55° C. for 5 minutes, and then rise at a rate of 5° C./min to 30° C.

The peak in the negative heat flow domain near −22° C. corresponds to heat absorption due to melting in both Example 3 and Comparative Example 2. The melting point was obtained from the intersection of the baseline and the tangent on the lower temperature side of the peak. The table lists practically the same melting point for Example 3 and Comparative Example 2. It is hence verified that the addition of disodium hydrogen phosphate little affects the melting point. The graph also shows a single heat absorption peak for Example 3. It is hence verified that the latent heat storage material of the present example forms a eutectic mixture. In other words, the eutectic mixture of sodium chloride, ammonium chloride, and water has a melting point of −24° C., although the eutectic mixture of sodium chloride and. water has a melting point of −21° C. The melting point can be adjusted by adding ammonium chloride as an inorganic salt other than sodium chloride.

The amounts of latent heat generated during melting as obtained from the area of the melting peaks hardly differed between Example 3 and Comparative Example 2, which verifies that the addition of disodium hydrogen phosphate practically hardly reduces the latent heat.

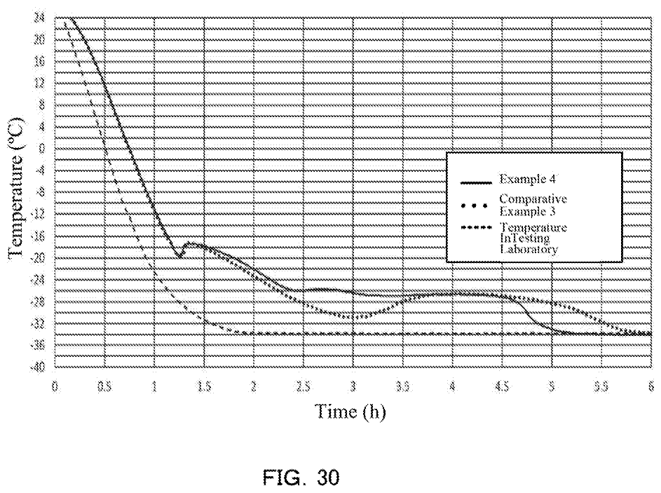

FIG. 30 is a graph representing results of measurement of the temperature of solutions during solidification using a thermocouple in a temperature-variable thermostatic chamber for Comparative Example 3 and Example 4. The sample solution for Comparative Example 3 was 50 grams of an aqueous solution obtained by mixing a 23wt % aqueous solution of sodium chloride, a 18 wt % aqueous solution of ammonium chloride, and a 20 wt % aqueous solution of potassium chloride in a proportion of 4:3:1. The sample solution for Example 4 was an aqueous solution obtained by adding, to 50 grams of an aqueous solution obtained by mixing a 23 wt % aqueous solution of sodium chloride, a 18 wt % aqueous solution of ammonium chloride, and a 20 wt % aqueous solution of potassium chloride (same solution as for Comparative Example 3), anhydrous disodium hydrogen phosphate up to a concentration of 1.0 wt %, which is greater than or equal to the saturation concentration at 0° C. The temperature-variable thermostatic chamber was operated by running a temperature program with such settings that the temperature would fall from 25° C. to −35° C. over 1 hour and then stay at −35° C.

The graph shows, for Comparative Example 3, that the temperature fell to a minimum onset temperature of solidification) of approximately −31° C. where supercooling stopped and that the aqueous solution subsequently solidified generating heat. The graph also shows, for Example 4, that the onset temperature of solidification was approximately −27° C. It is hence verified that the addition of disodium hydrogen phosphate restrains supercooling. Although solidification and melting were repeated more than once, solidification was still found stable.

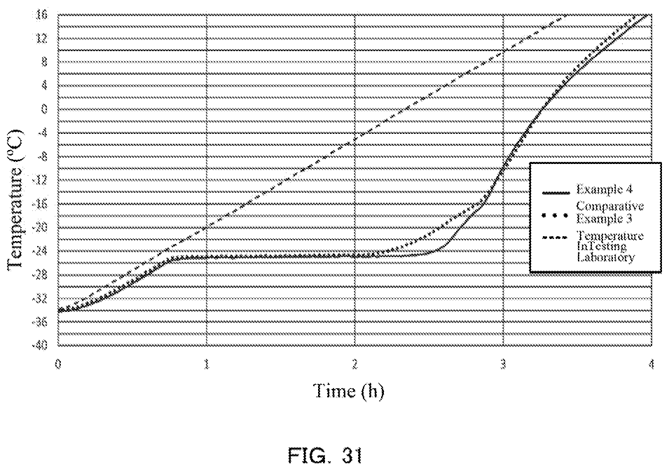

FIG. 31 is a graph representing results of measurement of the temperature of solutions during melting using a thermocouple in a temperature-variable thermostatic chamber for Example 4 and Comparative Example 3. The temperature-variable thermostatic chamber was operated by running a temperature program with such settings that the temperature would rise at a rate of 15° C./h starting from −35° C.

The graph shows, for both Example 4 and Comparative Example 3, that the temperature of the solution remaining constant due to heat absorption (from 0.6 hours to 2.6 hours into the experiment) coincided with melting and that the temperature remained at approximately −25° C. It is hence verified that the addition of disodium hydrogen phosphate little affects the melting point. The graph also shows that immediately after complete melting, the temperature started to rise with the rising internal temperature of the test chamber. It is hence verified that the addition of disodium hydrogen phosphate hardly reduces the latent heat.

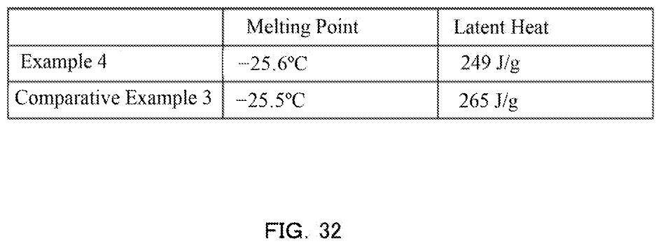

FIG. 32 is a table showing a melting point and the amount of latent heat generated during melting for Example 4 and Comparative Example 3. The table lists practically the same melting point for Example 4 and Comparative Example 3. It is hence verified that the addition of disodium hydrogen phosphate little affects the melting point and hardly reduces the latent heat.

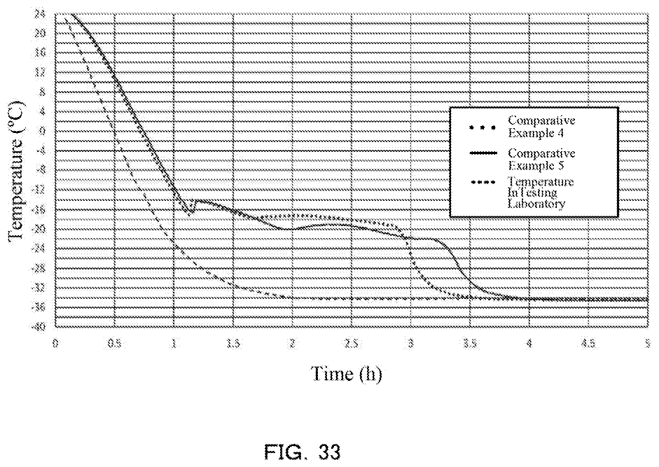

FIG. 33 is a graph representing results of measurement of the temperature of solutions during solidification using a thermocouple in a temperature-variable thermostatic chamber for Comparative Examples 4 and 5. The sample solution for Comparative Example 4 was 50 grams of an aqueous solution containing no sodium chloride and obtained by mixing a 18 wt % aqueous solution of ammonium chloride and a 20 wt % aqueous solution of potassium chloride in a proportion of 3:1. The sample solution for Comparative Example 5 was an aqueous solution obtained by adding, to 50 grams of an aqueous solution obtained by mixing a 18 wt % aqueous solution of ammonium chloride and a 20 wt % aqueous solution of potassium chloride in a proportion of 3:1 (same solution as for Comparative Example 4), anhydrous disodium hydrogen phosphate up to a concentration of approximately 1.0 wt %, which is greater than or equal to the saturation concentration at 0° C. The temperature-variable thermostatic chamber was operated by running a temperature program with such settings that the temperature would fall from 25° C. to −35° C. over 1 hour and then stay at −35° C0.

The graph shows that the addition of disodium hydrogen phosphate did not stop supercooling in Comparative Example 4 and that the solution froze at 19.7° C. to 22.2° C. in both Comparative Examples 4 and 5.

The discussion so far demonstrates that the addition of disodium hydrogen phosphate to a eutectic aqueous solution of an inorganic salt including no sodium chloride produces no supercooling inhibiting effect. It is thus understood that disodium hydrogen phosphate exhibits a remarkable supercooling inhibiting effect when the base material of the latent heat storage material is an aqueous solution of an inorganic salt including sodium chloride.

The present invention, in an embodiment thereof, may be arranged as follows. (1) The present invention, in an embodiment thereof, is directed to a latent heat storage material including an inorganic salt and water as a base material, wherein the inorganic salt includes at least sodium chloride, the inorganic salt and the water form a eutectic mixture, and the latent heat storage material contains disodium hydrogen phosphate in an amount that, in comparison with the base material, is greater than or equal to an amount that gives a saturation concentration at a temperature at which the eutectic mixture melts.

This composition enables a relatively small amount of disodium hydrogen phosphate added to unfailingly precipitate as crystals, thereby restraining supercooling, in the aqueous solution of an inorganic salt including sodium chloride. The composition also restrains changes in the concentration of the inorganic salt in the aqueous solution containing sodium chloride in precipitating as crystals, thereby less affecting the melting point and the cold insulation capability of the latent heat storage material. The composition thus enables maintaining the cold insulation capability of the latent heat storage material containing an aqueous solution of an inorganic salt including sodium chloride as a base material and enables the latent heat storage material to solidify in a stable manner near the melting point thereof. Furthermore, the composition, containing an inorganic salt other than sodium chloride, enables adjusting the melting point to a temperature other than the melting point of the eutectic mixture of sodium chloride and water.

(2) The latent heat storage material in accordance with the present invention, in an embodiment thereof, is configured such that the amount of the disodium hydrogen phosphate relative to the base material is less than or equal to an amount that gives a saturation concentration at 20° C.

This composition contains a non-excessive amount of disodium hydrogen phosphate, thereby restraining decreases in the amount of latent heat of the latent heat storage material while achieving a sufficient supercooling inhibiting effect.

(3) The latent heat storage material in accordance with the present invention, in an embodiment thereof, is configured such that the inorganic salt is sodium chloride, and the latent heat storage material described in (1) includes: an aqueous solution of sodium chloride having a eutectic concentration; and disodium hydrogen phosphate in an amount that, in comparison with the aqueous solution of sodium chloride having the eutectic concentration, is greater than or equal to an amount that gives a saturation concentration at 0° C.

This composition enables a relatively small amount of disodium hydrogen phosphate added to unfailingly precipitate as crystals, thereby restraining supercooling, in the aqueous solution of sodium chloride. The composition also restrains changes in the concentration of sodium chloride in the aqueous solution in precipitating as crystals, thereby less affecting the melting point and the cold insulation capability of the latent heat storage material. The composition thus enables maintaining the cold insulation capability of the latent heat storage material containing an aqueous solution of sodium chloride as a base material and enables the latent heat storage material to solidify in a stable manner near the melting point thereof.

(4) The latent heat storage material in accordance with the present invention, in an embodiment thereof, is configured such that the amount of the disodium hydrogen phosphate relative to the aqueous solution of sodium chloride having the eutectic concentration is less than or equal to an amount that gives a saturation concentration at 20° C.

This composition contains a non-excessive amount of disodium hydrogen phosphate, thereby restraining decreases in the amount of latent heat of the latent heat storage material while achieving a sufficient supercooling inhibiting effect.

(5) The present invention, in an embodiment thereof, is directed to a cold storage pack for cooling an object, the cold storage pack including: the latent heat storage material described in (1); and a container section containing the latent heat storage material.

This structure provides a cold storage pack containing a latent heat storage material, composed primarily of an aqueous solution of sodium chloride, that solidifies in a stable manner. The structure thus allows the latent heat storage material in the cold storage pack to solidify without having to use a special cooling device, thereby reducing cost in solidifying.

(6) The present invention, in an embodiment thereof, is directed to a cooling container including: a refrigerator compartment; and an electric cooling device configured to cool the refrigerator compartment, wherein the refrigerator compartment contains therein the aforementioned cold storage pack, and the electric cooling device has a control temperature at which at least the cold storage pack is frozen.

This structure enables the cold storage pack to solidify even in a cooling container including no special cooling device when there is a power supply available, thereby enabling the cooling container to maintain its internal temperature at or below −18° C. for an extended period of time when the power supply is disrupted.

(7) The present invention, in an embodiment thereof, is directed to a logistic packaging container for packaging an article, the logistic packaging container including: a logistic packaging container body; the cold storage pack described in (3); a cold-insulation-pack-holding section inside the logistic packaging container body, the cold-insulation-pack-holding section holding the cold storage pack; and an article housing section inside the logistic packaging container body, the article housing section housing the article.

This structure enables an article to be kept at or below −18° C. for an extended period of time during transport.

(8) The present invention, in an embodiment thereof, is directed to a cooling unit for cooling an object, the cooling unit including: a plurality of cold storage packs described in (3) around the object, the cold storage packs being formed like strips; and a cold-storage-pack holder around the cold storage packs, the cold-storage-pack holder supporting the cold storage packs and being configured to allow the cold storage packs to be placed in proximity to, or in contact with, the object.

This structure allows the cold storage packs to be placed in proximity to, or in contact with, the object. The object can be hence rapidly cooled even when the object and the cold. storage packs in the cooling unit have different temperatures.

(9) The cooling unit in accordance with the present invention, in an embodiment thereof, is configured such that the cold storage packs include an articulation mechanism coupling those cold storage packs that are adjacent.

This structure integrates the cold storage packs into a single body and still provides flexibility, thereby enhancing operability when the cold storage packs are placed around the object.

This international application claims the benefit of priority to Japanese Patent Application No. 2017-148381 filed Jul. 31, 2017, the entire contents of which are incorporated herein by reference.

### REFERENCE SIGNS LIST

100 Cold Storage Pack
110 Cold Storage Pack Main Body
120 Container Section
130 Thermal Storage Layer
150 Latent Heat Storage Material
170 Injection Hole
190 Plug
200 Logistic Packaging Container
210 Logistic Packaging Container Body
220 Cold-insulation-pack-holding Section
230 Article Housing Section
240 Container Section
250 Lid Section
300 Cooling Unit
310 Cold-storage-pack Holder
320 Articulation Mechanism
330 Fixing Mechanism
400 Cooling Container
410 Refrigerator Compartment

1. A latent heat storage material comprising an inorganic salt and water as a base material, wherein
the inorganic salt includes at least sodium chloride,
the inorganic salt and the water form a eutectic mixture, and
the latent heat storage material contains disodium hydrogen phosphate in an amount that, in comparison with the base material, is greater than or equal to an amount that gives a saturation concentration at a temperature at which the eutectic mixture melts.

2. The latent heat storage material according to claim 1, wherein the amount of the disodium hydrogen phosphate relative to the base material is less than or equal to an amount that gives a saturation concentration at 20° C.

3. The latent heat storage material according to claim 1, wherein the inorganic salt is sodium chloride, and
the latent heat storage material comprises:
an aqueous solution of sodium chloride having a eutectic concentration; and
disodium hydrogen phosphate in an amount that, in comparison with the aqueous solution of sodium chloride having the eutectic concentration, is greater than or equal to an amount that gives a saturation concentration at 0° C.

4. The latent heat storage material according to claim 3, wherein the amount of the disodium hydrogen phosphate relative to the aqueous solution of sodium chloride having the eutectic concentration is less than or equal to an amount that gives a saturation concentration at 20° C.,

5. A cold storage pack for cooling an object, the cold storage pack comprising:
the latent heat storage material according to claim 1; and
a container section containing the latent heat storage material.

6. A cooling container comprising:
a refrigerator compartment; and.
an electric cooling device configured to cool the refrigerator compartment, wherein
the refrigerator compartment contains therein the cold storage pack according to claim 5, and
the electric cooling device has a control temperature at which at least the cold storage pack is frozen.

7. A logistic packaging container for packaging an article, the logistic packaging container comprising:
a logistic packaging container body;
the cold storage pack according to claim 5;
a cold-insulation-pack-holding section inside the logistic packaging container body, the cold-insulation-pack-holding section holding the cold storage pack; and
an article housing section inside the logistic packaging container body, the article housing section housing the article.

8. A cooling unit for cooling an object, the cooling unit comprising:
a plurality of cold storage packs according to claim 5 around the object, the cold storage packs being formed like strips; and
a cold-storage-pack holder around the cold storage packs, the cold-storage-pack holder supporting the cold storage packs and being configured to allow the cold storage packs to be placed in proximity to, or in contact with, the object.

9. The cooling unit according to claim 8, wherein the cold storage packs include an articulation mechanism coupling those cold storage packs that are adjacent.

10. The latent heat storage material according to claim 1, wherein the inorganic salt includes ammonium chloride.

11. The latent heat storage material according to claim 1, wherein the inorganic salt includes ammonium chloride and potassium chloride.
